(19) United States
(12) Patent Application Publication
(10) Pub. No.: US 2005/0017939 A1
(43) Pub. Date: Jan. 27, 2005

(54) Display driver and image display method

(75) Inventor: Kouichi Sato, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 10/895,915

(22) Filed: Jul. 22, 2004

(30) Foreign Application Priority Data
Jul. 25, 2003 (JP) 2003-280419

(51) Int. Cl. G09G 3/36

(52) U.S. Cl. 345/89

(57) ABSTRACT

The driver for driving a flat display panel receives a selected tone data signal indicating a selected tone between black and white levels, and inserts an image determined by the selected tone data signal into video images. The driver has a tone register for storing selected tone data signals, from which a selected tone signal is sent to the flat display panel under the control of the timing control circuit.

### BACKGROUND OF THE INVENTION

1. Field of the Invention

The present invention relates to display drivers and, more particularly, to a liquid crystal display driver and a driving method of the driver.

2. Description of Related Art

Various types of flat panel display devices have been proposed, including liquid crystal display devices, plasma display panels, organic or inorganic electroluminescence displays. These flat panel display devices, and particularly liquid crystal display devices normally display video images one after another every frame period. Thus, one video image is retained for a specific frame period, and when a new video image is displayed while the previous video image is still retained, the human eye perceives overlapping images of the previous and new ones, causing a user to see a faint remnant of the previous image even after the new image has replaced it. The problem of residual image is especially significant in displaying moving images in which a response speed is partly high and partly low to cause image distortion.

As a way to eliminate the residual image, Japanese Unexamined Patent Application Publication No. 2001-42282, which is hereby incorporated, proposes a technique of inserting a black image at an appropriate interval. This conventional art particularly discloses a liquid crystal display device that alternately displays a black image and a video image, and a driving method of the display device.

The above conventional art also proposes a drive circuit (or data driver) for driving a liquid crystal panel. To generate black data constituting a black image which is different from a normal video image, the proposed data driver has a latch circuit for latching video image data constituting a video image and an AND circuit connected to the latch output of the latch circuit. If a SET pulse is Low, all outputs are set to Low and a black data is input to the AND circuit; if a SET pulse is High, video image data stored in the latch circuit is input to the AND circuit.

The inventors of the present invention, however, have found that inserting a black image between video images does not necessarily lead to optimal image display in the flat panel display devices and particularly liquid crystal display devices. For example, the insertion of the black image in liquid crystal cells constituting a liquid crystal display device can result in a decrease in luminance, and the rate of the luminance decrease can be different for each liquid crystal display device. This means that an optimal image varies for each liquid crystal display device depending on the characteristics and so on of a liquid crystal panel constituting the liquid crystal display device.

The above conventional art merely describes that display characteristics of moving images are improved by inserting a black image between video images, and it gives no indication to the fact that the insertion of the black image causes an optimal image to vary for each flat panel display, a problem caused by the variation in the optimal image, and a solution to the problem. Particularly, the conventional art does not mention the presence of such liquid crystal display devices that the luminance of image decreases by the insertion of the black image.

### SUMMARY OF THE INVENTION

In view of the foregoing, it is an object of the present invention to provide a display driver capable of reducing problems caused by the insertion of a black image in various displays, and particularly in liquid crystal display devices.

To these ends, according to one aspect of the present invention, there is provided a driver for a display comprising a tone register for storing a selected tone data signal indicating a selected tone; a data register for storing data signals different from the selected tone data signal; and an output circuitry for outputting the selected tone data signal.

The above driver may further comprise a timing control circuit for controlling output timing of the selected tone data signal stored in the tone register.

In the above driver, a tone indicated by the selected tone data signal may be variable between a black level and a white level. In this driver, the timing control circuit may control output timing of the selected tone data signal so as to insert a selected tone frame produced by the selected tone data signal every other frame so that a selected tone frame and a video image frame are displayed alternately. Alternatively, the timing control circuit may control output timing of the selected tone data signal so as to insert a selected tone image produced by the selected tone data signal so that inserted tone images in adjacent frames are in a complementary position with each other.

The above driver may be a driver for a liquid crystal display.

In the above driver, the output circuitry may comprise a selector for selecting between an output of the selected tone register and an output of the data register according to a timing signal from the timing control circuit. Further, in this driver, the selected tone data signal may indicate a reddish, bluish, or greenish tone different from a monotone.

The above driver may further comprise output terminals for outputting display signals; and a video image data register for storing video image data signals each of which corresponding to each of the output terminals, wherein the tone register stores a tone data signal corresponding to a plurality of output terminals of the output terminals, and an output circuitry outputs selectively display signals corresponding to the tone data signal stored in the tone register and video image data signals stored in the video image data register. In this driver, the tone register may be different from the video image data register. The tone register may store tone data of three different colors. Further, the tone data signal stored in the tone register may correspond to all of the plurality of output terminals.

According to another aspect of the present invention, there is provided a method of displaying an image by driving a display with a driver, comprising storing a selected tone data signal indicating a selected tone; in absence of a data signal to be displayed, reading the selected tone data signal, instead of the data signal, from the driver; and displaying a selected tone image on a screen.

According to still another aspect of the present invention, there is provided a display device displaying video images according to video image data, comprising a display panel comprising a display area having a plurality of pixels, for displaying images according to display signals; and a driver circuitry for outputting display signals to a plurality of pixels in the display area, the driver circuitry comprising video image data registers for storing video image data signals; a tone register for storing a tone data signal indicating a selected tone; and an output circuitry for outputting selectively display signals corresponding to the tone data signal stored in the tone register and video image data signals stored in the video image data register. In this display device, the tone register may be different from the video image data registers. The tone register may store tone data of three different colors. This display device may further comprise output terminals for outputting display signals, wherein each of the video image data registers stores video image data corresponding to each of the output terminals, and the tone register stores a tone data signal corresponding to a plurality of output terminals of the output terminals. Further in this display device, the display panel may be a liquid crystal display panel controlling a display image with an electric field applied to liquid crystal material.

According to yet another aspect of the present invention, there is provided a data driver comprising a first data register storing a first image data and then a second image data; a second data register storing a third image data; and a selector which outputs the first image data, the third image data and the second image data in that order.

According to another aspect of the present invention, there is provided a data driver comprising a first data register storing a plurality of video image data signals; and a second data register storing an intermediate tone image data signal.

The above driver may further comprises a selector coupled to the first and second registers to alternatively output the video image data signal and the intermediate tone image data signal to be displayed.

According to another aspect of the present invention, there is provided a data driver comprising a first register including a plurality of stages each storing a first image data signal; a second register storing a second image data; and a selector including a plurality of selector units, each of the selector units coupled to a corresponding one of the stages of the first register, each of the selector units coupled in common to the second register.

The present invention allows displaying video images most suitable for the image characteristics of each flat display panel by inserting a data signal having a tone according to the image characteristics of each panel. Particularly, the present invention allows adjustment of the image characteristics by changing a tone to be inserted.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a block diagram showing the entire structure of a liquid crystal display device according to the present invention.

FIG. 2 is a diagram showing the schematic structure of a liquid crystal panel shown in FIG. 1.

FIG. 3 is a block diagram showing the principal structure of a data driver according to a specific embodiment of the present invention.

FIG. 4 is a block diagram to specifically explain a data driver according to the present invention.

### DESCRIPTION OF THE PREFERRED EMBODIMENTS

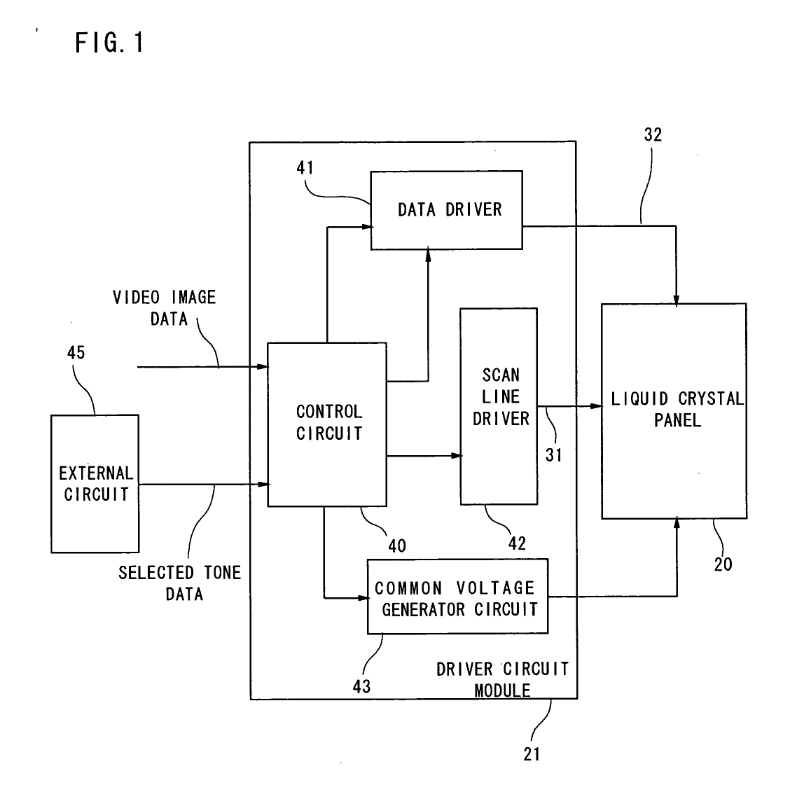

Referring first to FIG. 1, an example of a display to which the present invention is applicable, which is a liquid crystal display device in this embodiment, is shown. The liquid crystal display device has a liquid crystal panel 20 and a driver circuit module 21 for driving the liquid crystal panel 20. The liquid crystal panel 20 has NXM number of display elements, where N and Mare positive integers. An XGA monitor has (1024×3)×768 display elements.

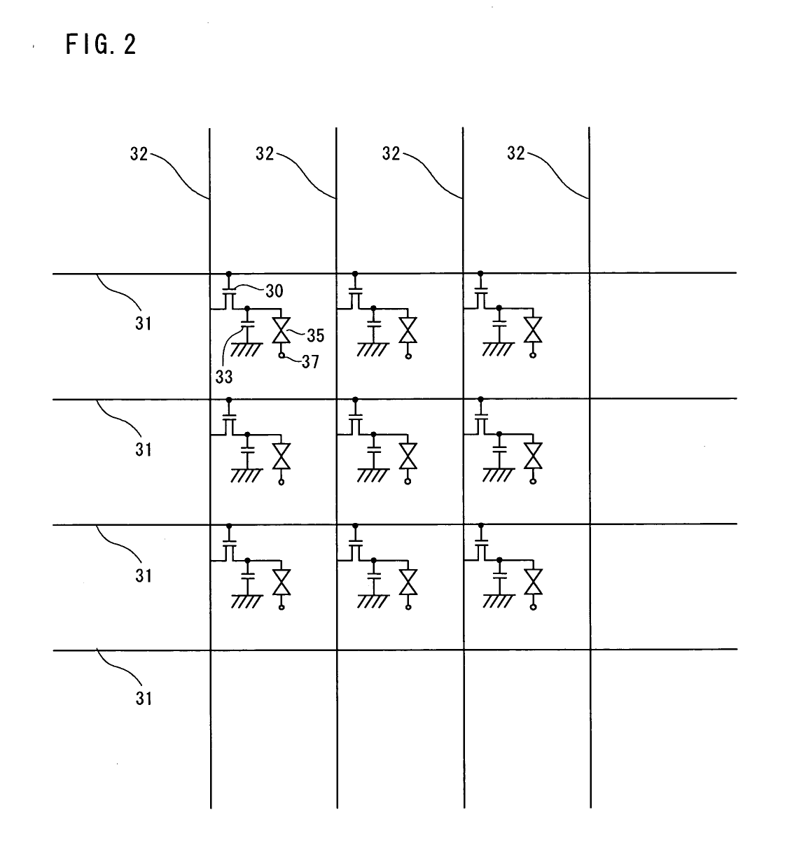

Referring next to FIG. 2, a part of the liquid crystal panel 20 in FIG. 1 is shown. As shown in FIG. 2, display elements constituting the liquid crystal panel 20 have TFTs 30 arranged in a matrix. Each TFT 30 has a gate electrode connected to a scan line 31 and a drain electrode connected to a data line 32. The display element of this embodiment has a capacitor 33 at a source electrode of the TFT 30. The source electrode of the TFT 30 is connected to a liquid crystal cell 35, on which a common (COM) electrode 37 is formed.

This liquid crystal panel 20 is driven by the driver circuit module 21 shown in FIG. 1. Referring back to FIG. 1, the driver circuit module 21 has a control circuit 40, a data driver 41, which is a liquid crystal display driver in this embodiment of the invention, a scan line driver 42, and a common (COM) voltage generator circuit 43. The scan line driver 42 and the data driver 41 are connected to the liquid crystal panel 20 by the scan line 31 and the data line 32, respectively. The common voltage generator circuit 43 is connected to the common electrode 37 of the liquid crystal panel 20 and normally supplies the common electrode 37 with a constant voltage signal.

Specifically, the control circuit 40 receives video image data and sends a data signal indicating the video image data to the data lines 32 via the data driver 41, while controlling the scan line driver 42 to sequentially select the scan line 31. Though a constant voltage is supplied to the common electrode 37 in this case, the structure for controlling the voltage may be employed depending on the structure of the liquid crystal cell 35, as described in the above conventional art.

Besides the image data, the control circuit 40 receives selected tone data indicating a given tone from an external circuit 45. The control circuit 40 has a function to distinguish between the image data and the selected tone data.

The selected tone data sent from the external circuit 45 is explained hereinbelow. As described in Japanese Unexamined Patent Application Publication No. 2001-42282 mentioned above, inserting a black image between video images at an appropriate interval allows reduction of residual images left when displaying moving images. However, the inventors of this invention have found that the insertion of the black image causes a decrease in the luminance of images in some liquid crystal panels since image characteristics vary by liquid crystal panels.

The present invention aims at displaying the video image most suitable for the image characteristics of each liquid crystal panel 20 by inserting a selected tone image instead of the black image. The insertion of the selected tone image causes no serious decrease in the display luminance compared to the insertion of the black image. For this reason, selected tone data for displaying a selected tone image is supplied to the control circuit 40 shown in FIG. 1 from the external circuit 45. The external circuit 45 has a button and so on for adjusting R, G, and B colors so as to set a given tone. Thus, the tone indicated by the selected tone data can be changed by adjusting the external circuit 45 in the embodiment shown in FIG. 1. The external circuit 45 is, for example, a color correction circuit of an image processor.

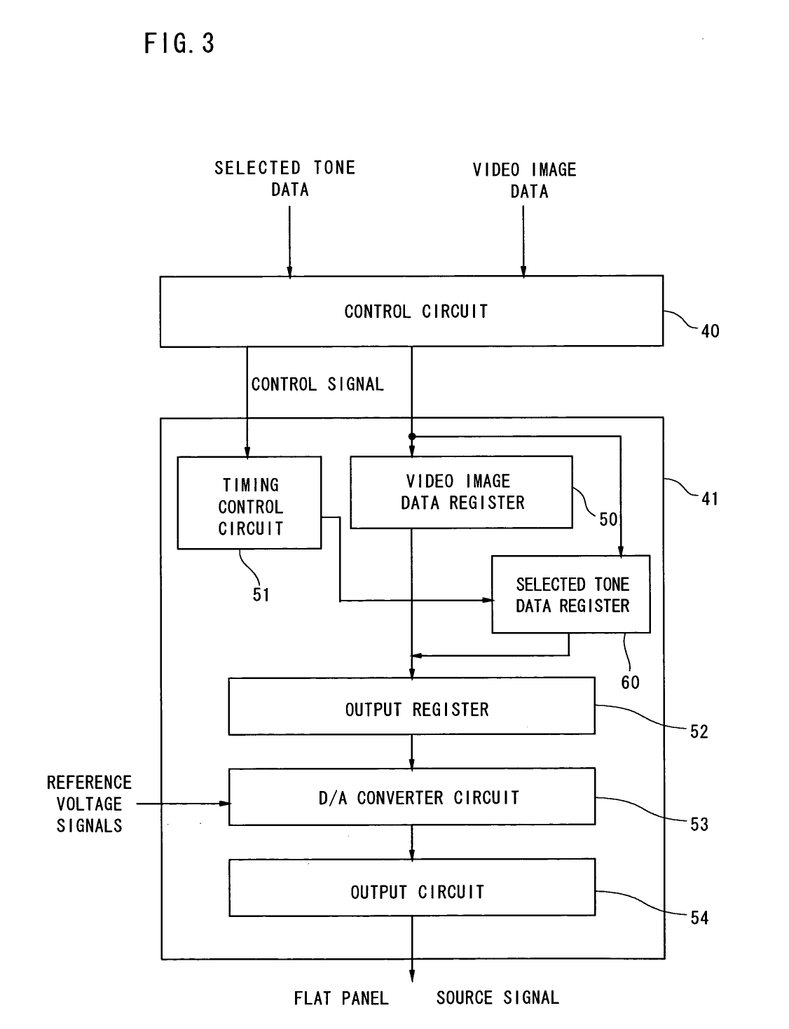

The principal structure of the data driver 41 according to a specific embodiment of the present invention is schematically explained hereinafter with reference to FIG. 3. The data driver 41 has a video image data register 50 for sequentially storing data signals indicating video image data into locations designated by a shift register and so on, a timing control circuit 51 for controlling the timing according to a control signal from the control circuit 40, an output register 52, a D/A converter circuit 53, and an output circuit 54 composed of an amplifier. The output circuit 54 is connected to the data lines 32 of the liquid crystal panel 20 via output terminals. The data driver 41 has the output terminals, each of which corresponds to each of the data lines 32. The video image data register 50, output register 52, D/A converter circuit 53, and output circuit 54 may be the same as conventional ones, and their detailed explanation is omitted.

The data driver 41 shown in FIG. 3 further has a selected tone data register 60 for storing selected tone data signals indicating a selected tone sent from the control circuit 40. For, example, a tone data is set to the tone data register 60 when the data driver is activated. The tone data register 60 holds the set tone data until the data driver becomes inactivated.

The selected tone data register 60 is connected to the control circuit 40 and also to the timing control circuit 51 in the data driver 41 to store selected tone data signals and output them to the output register 52 under the control of the timing control circuit 51.

The selected tone data signal indicating a selected tone from the control circuit 40 is sent to the output register 52 in the timing given by the timing control circuit 51, and then output to the data line 32 through the D/A converter circuit 53 and the output circuit 54.

In this embodiment, the selected tone data signal is output instead of a black image data signal indicating a black image. The timing control circuit 51 may insert the selected tone image in the same timing as the timing of inserting the black image described in the Japanese Unexamined Patent Application Publication No. 2001-42282 mentioned above.

For example, the timing control circuit 51 may control the selected tone data register 60 to send a selected target tone data signal to the output register 52 in such timing that a selected tone image and a video image are alternately displayed in adjacent frames. Then, the D/A converter circuit 53 receives the selected tone data signal and outputs a voltage indicating the selected tone, thereby displaying the selected tone image every other frame. The selected tone image may indicate a black level.

It is also possible, as described in the above conventional art, that a display screen in each frame is vertically and/or horizontally divided into two or more areas and the timing control circuit 51 controls the selected tone data register 60 so that a selected tone data signal is output instead of a video image data signal in such timing that the images in the divided areas of one frame and the images in an adjacent frame are switched alternately. In this case also, the selected tone image is displayed instead of the invariable black image in the divided area of the display screen, and the area where the selected tone image is displayed differs in each frame. Since the technique of dividing the display screen and changing the divided areas are widely known and also described in the above conventional art, the explanation is omitted here.

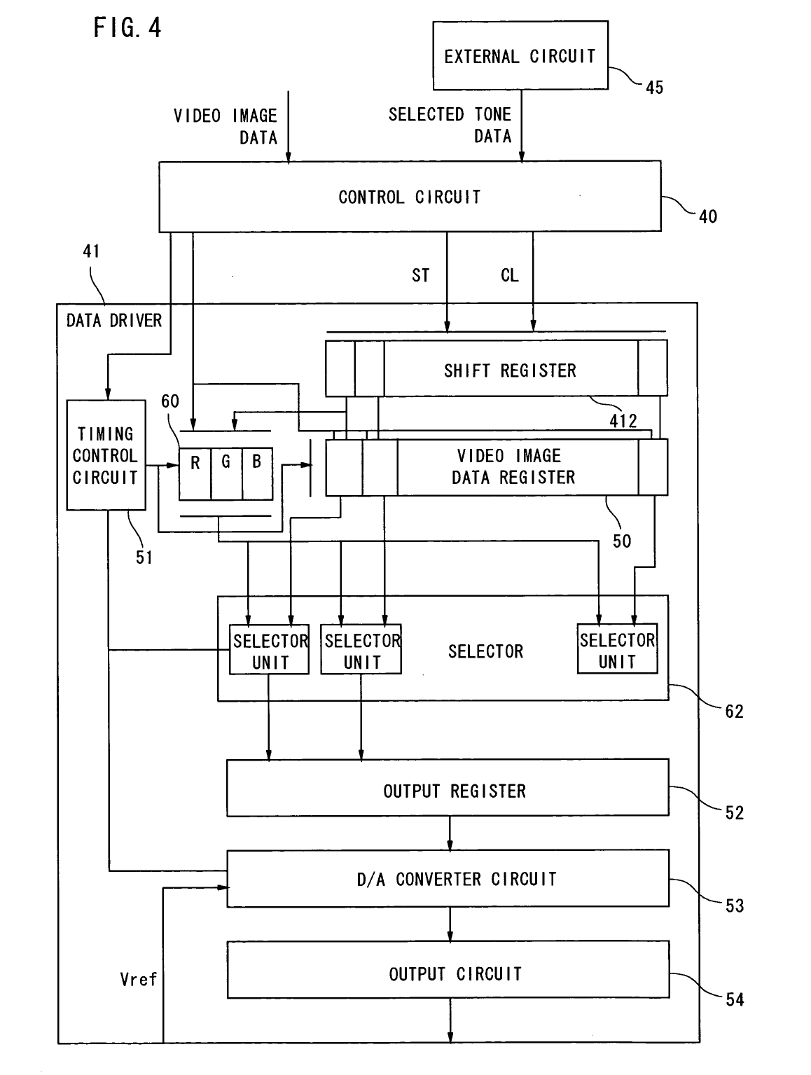

The data driver 41 according to this embodiment is now explained hereinafter in further detail with reference to FIG. 4. The control circuit 40 shown in FIG. 4 receives image data and selected tone data and then sends a video image data signal and a selected tone data signal to the data driver 41 through a common data bus; at the same time, it distinguishes between the two data signals and sends a control signal to the data driver 41. The video image data signal and the selected tone data signal are given in pixels, and each pixel is composed of Red, Green, and Blue dots. Each color has a given number of tone levels, and R, G, and B are each represented by a given number of bits (for example, 8 bits or 6 bits). Thus, a data signal corresponding to a pixel is referred to here as a data unit. Further, the control circuit in FIG. 4 outputs a start signal ST and a clock signal CL to the data driver 41.

As shown in FIG. 4, the data driver 41 has a shift register 412 that operates by receiving the start signal ST and clock signal CL. The shift register 412 is, for example, composed of a plurality of stages of D Flip-Flops (DFFs) connected in series. The shift register 412 is initialized by a start signal ST generated from a horizontal synchronizing signal, and upon receiving a clock signal CL, one DFF is set to “1” while the other DFFs remain at “0”. The DFFs in the shift register 412 become “1” in turn according to the clock signal CL, and the signal indicating “1” is sequentially output from each DFF as a position indication signal.

The position indication signal generated in the shift register 412 is sent to the video image data register 50 and the selected tone data register 60 in the data driver 41 to activate the registers 50 and 60 so that they can store the data. The video image data register 50 and the selected tone data register 60 are connected to the control circuit 40 by a common bus.

The video image data register 50 has a plurality of stages, each connected to each stage of the shift register 512. The stages of the video image data register 50 are sequentially activated according to the position indication signals from the shift register 412 to store video image data signals in pixels.

The selected tone data register 60, on the other hand, stores a signal in pixel, which is, data unit. The register 60 is divided into R, G, and B stages in this example to simplify the explanation. The selected tone data register 60 is connected to a particular stage of the shift register 412 to store the data signal in pixel corresponding to the particular stage. In this embodiment, the selected tone data register 60 is connected to the first stage of the shift register 412.

Further, the video image data register 50 and the selected tone data register 60 are both connected to the timing control circuit 51. The register 50 or 60 is selectively activated by a timing signal from the timing control circuit 51.

When the video image data register 50 is activated by the timing signal from the timing control circuit 51, the video image data signal from the control circuit 40 is sequentially stored in data units in each stage of the video image data register 50 according to the position indication signal from the shift register 412. When, on the other hand, the selected tone data register 60 is activated, the selected tone data signal from the control circuit 40 is stored in data units in the selected tone data register 60 according to the position indication signal from the shift register 412.

The video image data register 50 sequentially stores the data signals indicating video images in the horizontal scan direction according to the position indication signal. Specifically, the video image data register 50 has a plurality of registers, in which a data signal for one horizontal scanning is stored.

A selector 62 is composed of a plurality of selector units, each connected to the selected tone data register 60 and also to a corresponding stage of the video image data register 50. The selector 62 selects between the output of the selected tone data register 60 and the output of the video image data register 50 according to a selection signal sent as the timing control signal from the timing control circuit 51, and then sends the selected output to the output register 52.

Now, the operation of the data driver 41 when the shift register 412 is activated by the start signal ST and the clock signal CL is explained below. If the control circuit 40 receives a video image data signal, it outputs a control signal indicating the normal video image data signal to the timing control circuit 51. In this case, the timing control circuit 51 outputs a timing signal to activate the video image data register 50. The video image data signal from the control circuit 40 is thereby stored into each stage of the video image data register 50 in data units according to the position indication signal from the shift register 412.

On the other hand, if the control circuit 40 receives a selected tone data signal, it identifies the received signal as a selected tone data signal and sends a control signal indicating the selected tone data signal to the timing control circuit 51. Receiving the control signal, the timing control circuit 51 activates the selected tone data register 60, and the selected tone data signal from the control circuit 40 is stored in the selected tone data register 60.

The outputs from the video image data register 50 and the selected tone data register 60 are each supplied to the corresponding selector unit of the selector 62. The selector units constituting the selector 62 are controlled by the timing signal from the timing control circuit 51 to select between the output of the video image data register 50 and the output of the selected tone data register 60.

Specifically, to display a normal video image on the liquid crystal panel 20, the selector 62 sequentially selects the video image data signals stored in the video image data register 50 according to the timing signal from the timing control circuit 51. The video image data signals are then sent to the liquid crystal panel 20 via the output register 52, the D/A converter circuit 53, the output circuit 54, thereby displaying the normal video image on the liquid crystal panel 20. The timing control circuit 52 thus continuously outputs the timing signals to the selector 62 during the normal video image display mode.

On the other hand, to display a selected tone image on the liquid crystal panel 20, the control circuit 40 outputs a control signal indicating the selected tone data signal to the timing control circuit 51. The timing control circuit 51 thereby outputs the timing signal for controlling the selector 62 to select the selected tone data register 60. The selected tone data register 60 is connected to the selector units of the same number as the number of stages of the data register 50, and the selector 62 sequentially selects the selected tone data signals for each pixel and sends the signals to the output register 52. The selected tone data signals are then sent to the liquid crystal panel 20 via the D/A converter circuit 53 and the output circuit 54, thereby displaying the image of the selected tone level on the liquid crystal panel 20.

More specifically, if the selector units of the selector 62 select the output of the selected tone data register 60, the output register 52 sends a selected target tone data signal stored in the RGB stages of the selected tone data register 60 to the D/A converter 53. The D/A converter 53 then converts the selected target tone data signal into an analog tone signal corresponding the target tone based on a reference voltage Vref and sends the analog tone signal via the output circuit 54 to the liquid crystal display panel 20 through the data line 32.

The data driver 41 of this structure allows control of the time of displaying the selected tone image by controlling the duration of the timing signal sent from the timing control circuit 51 to the selector 62 and/or the D/A converter circuit 53. For example, to alternately display the selected tone image and the video image every other frame, the timing control circuit 51 may send a timing signal for selecting the selected tone data register 60 every other frame to the selector 62 and/or the D/A converter circuit 53 so as to send the selected tone data signal output from the register 60 to the liquid crystal panel 20. On the other hand, to switch the selected tone image and the video image in one frame, the timing control circuit 51 may send a timing signal according to the screen switch timing to the selector 62 and/or the D/A converter circuit 53. For example, the timing of inserting the selected tone image in a frame may be the same as that of the black image described in the Japanese Unexamined Patent Application Publication No. 2001-42282 mentioned above.

The data driver 41 shown in FIG. 4 also allows determining a tone to produce the image most suitable for the image characteristics of the liquid crystal panel 20 by changing the selected tone data signal supplied to the selected tone data register 60. The data driver 41 further allows changing the pattern of the selected target tone image by changing the timing signal in the timing control circuit 51.

The selected tone data signal inserted into the normal video image data signal is now explained. The selected tone data signal is determined in a color correction circuit of an image processor and so on placed in the upper stage of the control circuit 40. In this case, the level of the selected tone data signal is selected according to the characteristics such as color reproducibility of the liquid crystal panel 20 and the purposes. For example, the level close to black may be selected to improve the moving image characteristics, and the level of a bluish or reddish color may be selected to display monochrome images.

An example of experimental results relating to the method of selecting the selected tone data signal is explained hereinafter. Black and while data signals displayed on the liquid crystal panel 20 are represented in hexadecimal as (R=FFH, G=FFH, B=FFH) and (R=OOH, G=OOH, B=OOH), respectively. Inserting a black data signal (R=FFH, G=FFH, B=FFH) improved the moving image characteristics. However, the insertion of the black data signal resulted in decrease in the luminance of images in some liquid crystal panel 20. Then, a selected tone data signal of (R=FOH, G=FOH, B=FOH) was inserted in this liquid crystal panel 20, which improved the moving image characteristics without decreasing the luminance. The data signal of (R=FOH, G=FOH, B=FOH) maybe called an intermediate tone image data signal.

As obvious from this experiment, it is possible to improve the characteristics other than the moving image characteristics by setting the level of the selected tone data signal according to the characteristics of the liquid crystal panel 20 and/or the type of the image to be displayed.

Though the data driver 41 having the structure shown in FIG. 4 selectively activates the video image data register 50 or the selected tone data register 60 according to the timing signal supplied as a control signal from the timing control circuit 51, the data driver according to this invention may have such a structure as to activate the selected tone data register 60 at the same time as the video image data register 50.

Further, though the above embodiment explains the case where the data driver 41 operates to insert the selected tone image between the video images, the data driver according to this invention is not limited thereto, but maybe applied to adjustment of image characteristics of the liquid crystal panel and so on. The data driver 41 may have a plurality of selected tone data registers 60, each of which stores different tone data. Though the selected tone data register 60 is preferably a different unit from the video image data register 50 in terms of controllability, a part of the stages of the video image data register 50 may function as the selected tone data register 60.

Specifically, though noise appears on a TV screen after TV broadcasting service is ended, it is possible to adjust the image characteristics by sending a selected tone data signal from the data driver to the liquid crystal panel after the service is over. In this case, the selected tone data signal to be inserted may have a bluish, reddish, or greenish level.

Although the above embodiments are explained in conjunction with the liquid crystal display device, the present invention may be also applicable to other flat panels in which display elements are arranged in matrix, including PDP, organic EL, and inorganic EL.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A driver for a display, comprising:
a tone register for storing a selected tone data signal indicating a selected tone;
a data register for storing data signals different from the selected tone data signal; and
an output circuitry for outputting the selected tone data signal.

2. The driver according to claim 1, further comprising a timing control circuit for controlling output timing of the selected tone data signal stored in the tone register.

3. The driver according to claim 1, wherein a tone indicated by the selected tone data signal is variable between a black level and a white level.

4. The driver according to claim 2, wherein the timing control circuit controls output timing of the selected tone data signal so as to insert a selected tone frame produced by the selected tone data signal every other frame so that a selected tone frame and a video image frame are displayed alternately.

5. The driver according to claim 2, wherein the timing control circuit controls output timing of the selected tone data signal so as to insert a selected tone image produced by the selected tone data signal so that inserted tone images in adjacent frames are in a complementary position with each other.

6. The driver according to claim 1, wherein the driver is a driver for a liquid crystal display.

7. The driver according to claim 2, wherein the output circuitry comprises a selector for selecting between an output of the selected tone register and an output of the data register according to a timing signal from the timing control circuit.

8. The driver according to claim 7, wherein the selected tone data signal indicates a reddish, bluish, or greenish tone different from a monotone.

9. The driver for a display according to claim 1, further comprising output terminals for outputting display signals,
wherein the data register is a video image data register for storing video image data signals each of which corresponding to each of the output terminals,
the tone register stores a tone data signal corresponding to a plurality of output terminals of the output terminals, and
an output circuitry outputs selectively display signals corresponding to the tone data signal stored in the tone register and video image data signals stored in the video image data register.

10. The driver according to claim 9, wherein the tone register is different from the video image data register.

11. The driver according to claim 9, wherein the tone register stores tone data of three different colors.

12. The driver according to claim 9, wherein the tone data signal stored in the tone register corresponds to all of the plurality of output terminals.

13. A method of displaying an image by driving a display with a driver, comprising:
storing a selected tone data signal indicating a selected tone;
in absence of a data signal to be displayed, reading the selected tone data signal, instead of the data signal, from the driver; and
displaying a selected tone image on a screen.

14. A display device displaying video images according to video image data, comprising:
a display panel comprising a display area having a plurality of pixels, for displaying images according to display signals; and
a driver circuitry for outputting display signals to a plurality of pixels in the display area, the driver circuitry comprising:
video image data registers for storing video image data signals;
a tone register for storing a tone data signal indicating a selected tone; and
an output circuitry for outputting selectively display signals corresponding to the tone data signal stored in the tone register and video image data signals stored in the video image data register.

15. The display device according to claim 14, wherein the tone register is different from the video image data registers.

16. The display device according to claim 14, wherein the tone register stores tone data of three different colors.

17. The display device according to claim 14, further comprising output terminals for outputting display signals,
wherein each of the video image data registers stores video image data corresponding to each of the output terminals, and
the tone register stores a tone data signal corresponding to a plurality of output terminals of the output terminals.

18. The display device according to claim 14, wherein the display panel is a liquid crystal display panel controlling a display image with an electric field applied to liquid crystal material.

19. A data driver, comprising:
a first data register storing a first image data and then a second image data;
a second data register storing a third image data; and
a selector which outputs the first image data, the third image data and the second image data in that order.

20. A data driver, comprising:
a first data register storing a plurality of video image data signals; and
a second data register storing an intermediate tone image data signal.

21. The driver according to claim 20, further comprising a selector coupled to the first and second registers to alternatively output the video image data signal and the intermediate tone image data signal to be displayed.

22. A data driver, comprising:
a first register including a plurality of stages each storing a first image data signal;
a second register storing a second image data; and
a selector including a plurality of selector units, each of the selector units coupled to a corresponding one of the stages of the first register, each of the selector units coupled in common to the second register.
